(19) United States
(12) Patent Application Publication
(10) Pub. No.: US 2015/0362822 A1
(43) Pub. Date: Dec. 17, 2015

(54) METHOD OF PRODUCING A REVEALABLE INVISIBLE PATTERN IN A TRANSPARENT CONDUCTIVE FILM

(71) Applicant: Carestream Health, Inc., Rochester, NY (US)

(72) Inventors: Kiarash Vakhshouri, Lompoc, CA (US); Tryg R. Jensen, Roseville, MN (US); Erin R. Bell, Woodbury, MN (US)

(21) Appl. No.: 14/712,055

(22) Filed: May 14, 2015

Related U.S. Application Data
(60) Provisional application No. 62/010,489, filed on Jun. 11, 2014.

(51) Int. Cl. G02F 1/17; G02F 1/01

(52) U.S. Cl. CPC G02F 1/17; G02F 1/0102

(57) ABSTRACT

A transparent conductive film comprising at least one patterned region comprising a first concentration of at least one radiation absorbing compound and exhibiting a first surface resistivity, at least one unpatterned region comprising a second concentration of the at least one radiation absorbing compound and exhibiting a second surface resistivity, the second concentration being different from the first concentration and the second surface resistivity being different from the first surface resistivity, where the at least one patterned region and the at least one unpatterned region are indistinguishable from each other to the unaided human eye, and where the at least one radiation absorbing compound is capable of rendering the at least one patterned region and at least one unpatterned region distinguishable from each other to the unaided human eye when the at least one radiation absorbing compound is exposed to radiation within a defined band of wavelengths.

### CROSS REFERENCE TO RELATED APPLICATIONS

This application claims the benefit of U.S. Provisional Application No. 62/010,489, filed Jun. 11, 2014, entitled “METHOD OF PRODUCING A REVEALABLE INVISIBLE PATTERN IN A TRANSPARENT CONDUCTIVE FILM,” which is hereby incorporated by reference in its entirety.

### BACKGROUND

Transparent conductive films are used in electronic applications, such as touch screen sensors for portable electronic devices. Transparent conductive films comprising silver nanowires are particularly well suited for such applications because of their flexibility, high conductivity, and high optical transparency.

For many electronic applications, such transparent conductive films are patterned in order to provide low resistivity regions separated by high resistivity regions. For commercial applications, the transparent conductor must have a patterned conductivity that can be produced in a low-cost, high-throughput process.

In some applications, it may be desirable that the pattern in the transparent conductor that is incorporated into the end product is invisible to the unaided eye. For example, a visible pattern may block information that is displayed on a touch screen device. However, during manufacturing of the end product, it may be desirable that the pattern be visible under certain conditions for purposes, such as verifying the pattern or aiding the application of ink onto the pattern.

There have been attempts to provide methods of concealing information in different articles from the unaided eye that may be revealed through activating a substance embedded the articles. Such methods have been used to prevent counterfeiting of security documents, such as back notes, checks, passports, credit cards, stock certificates, etc. from unauthorized reproduction. In some of these attempts, a radiation absorbing substance was used. See, for example, EP 1348575 and WO 2003/080364 each to Landqart, U.S. Pat. No. 4,451,521 to Kaule et al., and U.S. Pat. No. 7,513,437 to Douglas. In some cases, radiation absorbing substances were incorporated into transparent conductive films. See, for example, US Patent Publication No. 2012/0258305 to Haruta et al., US Patent Publication No. 2012/0292725 to Christoforo et al., and U.S. Pat. No. 3,365,324 to Blake.

### SUMMARY

At least a first embodiment comprises a transparent conductive film comprising at least one patterned region comprising a first concentration of at least one radiation absorbing compound and exhibiting a first surface resistivity, at least one unpatterned region comprising a second concentration of the at least one radiation absorbing compound and exhibiting a second surface resistivity, the second concentration being different from the first concentration and the second surface resistivity being different from the first surface resistivity, where the at least one patterned region and the at least one unpatterned region are indistinguishable from each other to the unaided human eye, and also where the at least one radiation absorbing compound is capable of rendering the at least one patterned region and at least one unpatterned region distinguishable from each other to the unaided human eye when the at least one radiation absorbing compound is exposed to radiation within a defined band of wavelengths.

In some such embodiments, the radiation absorbing substance comprises metal oxide, such as, for example, zinc oxide.

In some such embodiments, the defined band of wavelengths is within the ultraviolet spectrum of between about 400 nm and about 10 nm. In others, the defined band of wavelengths is within the infrared spectrum of between about 700 nm to about 1 mm.

In some cases, the transparent conductive film further comprises a conductive layer comprising conductive structures, wherein the at least one radiation absorbing substance is disposed in the conductive layer.

In some cases, the transparent conductive film further comprises a top coat layer, wherein the at least one radiation absorbing substance is disposed in the top coat layer.

In some cases, the first concentration or the second concentration is zero.

At least a second embodiment comprises a method of using the transparent conductive film according to any of the above embodiments, the method comprising rendering the at least one patterned region and at least one unpatterned region distinguishable from each other to the unaided human eye by increasing exposure of the transparent conductive film to radiation within the defined band of wavelengths.

Some such methods further comprise rendering the at least one patterned region and at least one unpatterned region to be once again indistinguishable from each other to the unaided human eye by decreasing exposure of the transparent conductive film to radiation within the defined band of wavelengths.

### DESCRIPTION OF FIGURES

FIG. 1 is an ultraviolet-visible spectrum of a film having a top coat that has a ZnO to top coat ratio of 0.01 to 1 and ZnO with an average particle diameter of 40 nm before etching, after etching, and after stripping.

FIG. 2 is an ultraviolet-visible spectrum of a film having a top coat that has a ZnO to top coat ratio of 0.03 to 1 and ZnO with an average particle diameter of 40 nm before etching, after etching, and after stripping.

FIG. 3 is an ultraviolet-visible spectrum of a film having a top coat that has a ZnO to top coat ratio of 0.01 to 5 and ZnO with an average particle diameter of 40 nm before etching, after etching, and after stripping.

FIG. 4 is an ultraviolet-visible spectrum of films having a top coat that has a ZnO to top coat ratio of 0.01 to 5 and having no ZnO or ZnO with an average particle diameters of 20 nm or 40 nm.

### DESCRIPTION

All publications, patents, and patent documents referred to in this document are incorporated by reference herein in their entirety, as though individually incorporated by reference.

U.S. Provisional Application No. 62/010,489, filed Jun. 11, 2014, entitled “METHOD OF PRODUCING A REVEALABLE INVISIBLE PATTERN IN A TRANSPARENT CONDUCTIVE FILM,” is hereby incorporated by reference in its entirety.

A transparent conductive film may comprise a conductive layer and a top coat layer disposed on the conductive layer. The conductive layer may, for example, comprise conductive structures embedded or dispersed in a matrix. The transparent conductive film may comprise at least one first patterned region and at least one second unpatterned region that have different surface resistivities and that are indistinguishable from each other to the unaided human eye.

While it may be desirable that any pattern in the transparent conductive film remain invisible to the eye after incorporation into an end product, it may also be desirable that such pattern can be made detectable to the eye when desired. We have discovered that incorporation of a radiation absorbing substance that absorbs radiation within a defined band of wavelengths can make the at least one patterned region and the at least one unpatterned region distinguishable from each other to the unaided human eye when exposed to a radiation within that band of wavelengths.

### Conductive Structures

The conductive structures can be formed from any conductive material. In some cases, conductive structures are made from a metallic material, such as elemental metal (e.g. transition metal) or a metal compound (e.g. metal oxide). The metallic material can also be a bimetallic material or metal alloy, which comprises two or more types of metal. Non-limiting examples of suitable metals include silver, gold, copper, nickel, gold-plated silver, platinum, and palladium.

Such conductive structures can be any shape or geometry, such as nanowires, particles, nanotubes, and nanorods. The conductive structures may be nano-sized structures (i.e. conductive nanostructures), where at least one dimension (e.g. diameter, length, or width) of the conductive structures is less than 500 nm, or in some cases, less than 100 nm or 50 nm. For example, silver nanowires may have diameter ranges of 10 nm to 120 nm, 25 nm to 35 nm, 30 to 33 nm, 35 nm to 45 nm, 55 nm to 65 nm, or 80 to 120 nm. Such silver nanowires may have average diameters of 30 nm, 40 nm, 60 nm, or 90 nm. Such silver nanowires may have lengths greater than 500 nm, 1 μm, or 10 μm.

Other non-limiting examples of conductive structures include nanowires, metal meshes, nanotubes (e.g. carbon nanotubes), conductive oxides (e.g. indium tin oxide), graphene, and conductive polymer fibers.

### Matrix

Matrix, which may also be referred to as binder in some cases, refers to a material in which conductive structures (e.g. silver nanowires) are embedded or dispersed. The conductive structures and the matrix form the conductive layer disposed on a substrate that makes up the film. The matrix may provide structural integrity to the conductive layer.

In some embodiments, the matrix comprises an optically clear or optically transparent material. By “optically clear” or “optically transparent,” we mean that light transmission of the material is at least 80% in the visible region (approximately 400 nm to 700 nm). A polymer may be an optically clear or optically transparent material. Non-limiting examples of optically clear or optically transparent polymers include cellulosic polymers, such as cellulose esters, which include, for example, cellulose acetate polymers, which include, for example, cellulose acetate butyrate or acrylate polymers, such as methacrylate polymers, which include, for example, ethyl methacrylate copolymer.

### Top Coat Layer

In a transparent conductive film, the top coat layer is disposed onto the conductive layer. Other layers may be disposed onto the top coat layer. In some embodiments, the top coat layer comprises an optically clear or optically transparent material. By “optically clear” or “optically transparent,” we mean that light transmission of the material is at least 80% in the visible region (approximately 400 nm to 700 nm). A polymer may be an optically clear or optically transparent material. Non-limiting examples of optically clear or optically transparent polymers include cellulosic polymers, such as cellulose esters, which include, for example, cellulose acetate polymers, which include, for example, cellulose acetate butyrate.

### Radiation Absorbing Substance

In some embodiments, it may be desirable to produce an invisible pattern that can be made visible or detectable to the eye when needed. To produce a revealable invisible pattern, a radiation absorbing substance that absorbs radiation from a selected wavelength range that can make the pattern visible to the eye when the film is irradiated with radiation having the selected wavelength range may be incorporated into the film.

In some embodiments, the radiation absorbing substance may comprise an ultraviolet (UV) radiation absorbing substance that absorbs radiation in the ultraviolet region of the electromagnetic spectrum, which has a wavelength range between about 400 nm and about 10 nm. An example of a radiation absorbing substance is metal oxides. An exemplary example of a metal oxide is ZnO. Other non-limiting examples of metal oxides include TiO₂, CeO₂, SnO₂, In₂O₃, and Sb₂O₃. In some embodiments, the radiation absorbing substance may comprise infrared (IR) radiation absorbing substance that absorbs radiation in the infrared region of the electromagnetic spectrum, which has a wavelength range between about 700 nm to about 1 mm.

In some embodiments, the conductive layer may comprise the radiation absorbing substance. In such cases, the radiation absorbing substance may be added to the coating solution for coating a support to produce the conductive layer. In some embodiments, the top coat layer may comprise the radiation absorbing substance. In such cases, the radiation absorbing substance may be added to the coating solution for coating the conductive layer to produce the top coat layer. In some embodiments, the transparent conductive film may comprise an undercoat layer disposed between the conductive layer and the support, and the undercoat layer may comprise the radiation absorbing substance. In such cases, the radiation absorbing substance may be added to the coating solution for coating a support to produce the undercoat layer.

In some embodiments, the transparent conductive film may comprise at least one first undercoat layer disposed on the first side of the substrate between the first conductive layer and the substrate, and at least one second undercoat layer disposed on the second side of the substrate between the second conductive layer and the substrate. In such cases, any of the layers may comprise a radiation absorbing substance.

It is contemplated that more than one layer of a transparent conductive film may comprise a radiation absorbing substance.

### Patterning

To produce regions of different conductivity in a transparent conductive film, a conductive layer may be patterned by various treatment methods, such as, for example, etching or leaching. (Patterning by leaching is described in U.S. patent application Ser. No. 14/680,131, filed Apr. 7, 2015, entitled “PATTERNED FILMS AND METHODS,” which is hereby incorporated by reference in its entirety.) In some embodiments, the pattern is invisible to the unaided human eye.

Etchants may be applied to a film using various methods. In one example, a mask may be screen printed onto the film according to a pattern to minimize etchant exposure in masked regions to form an unetched region and the etchant may be applied to the film to etch the film in unmasked regions to form an etched region through methods, such as spraying the etchant onto the film or dipping the film into the etchant. In another example, the etchant may be screen printed onto the film according to a pattern to form an etched region. The pattern may comprise only a portion or the entire film. If the pattern is the entire film, the etchant may be applied to the entire surface of the film through methods, such as spraying the entire film with etchant or dipping the entire film into the etchant. After the etching step, depending on the type of printed mask, it can be removed either by peeling off from the transparent conductive film or by rinsing with stripping agents such as 5 wt % sodium hydroxide in water.

The film may be exposed to the etchant for various etching times, such as 30 seconds, 1 minute, or 5 minutes. The etching process may be stopped by various methods, such as rinsing with water or other neutralizer, such as sodium hydroxide. If used, the mask or screen printed etchant paste may be stripped from the film.

The patterning process may alter the conductive structures, thereby changing the conductivity of the regions comprising such conductive structures, and deactivate the radiation absorbing features of the radiation absorbing substance. Without wishing to be bound by theory, the etchant may alter the chemical structure of the radiation absorbing substance and/or the radiation absorbing substance may be rinsed off the film and/or stripped off the film. In the case where ZnO is the radiation absorbing substance and nitric acid is the etchant, the etchant may dissolve ZnO from the film through the reaction

ZnO+2HNO₃→Zn(NO₃)₂+H₂O

where Zn(NO₃)₂ is soluble in nitric acid and/or water and/or rinsing agent.

The radiation absorbing substance in areas that are not exposed to the etchant (e.g. under masked areas or areas that is not screen printed with an etchant) remains in the film.

### Etching Composition

Various etchants or etchant solutions may be used. Etchants may comprise at least one of the following components: at least one solvent, at least one acid, at least one metal halide, at least one surfactant, and at least one polymer. For example, an etchant may comprise at least one mineral acid (or inorganic acid) or at least one metal halide and either at least one organic acid or at least one surfactant and optionally a polar solvent, such as water or alcohol. The etchant may be an aqueous etching solution in which the solvent comprises water. The etchant may be an etching solution in which the solvent comprises an alcohol.

A mineral acid, also referred to an inorganic acid, is an acid derived from at least one inorganic compound. An inorganic compound lacks carbon and hydrogen atoms. When dissolved in water, the mineral acid forms hydrogen ions and conjugate base ions. Non-limiting examples of mineral acids include hydrochloric acid, phosphoric acid, nitric acid, and combinations thereof, such as aqua regia. Aqua regia, which is also known as aqua regia or nitro-hydrochloric acid, is a mixture formed from nitric acid and hydrochloric acid. In an aqua regia mixture, the acids may be in concentrated form, and the volume ratio of nitric acid to hydrochloric acid may be about 1:3.

A metal halide is a compound formed from a metal and a halogen. Metals may be found in groups 1-15 of the periodic table. Subgroups of metals include, for example, alkali metals, alkaline earth metals, transition metals, post-transition metals, lanthanides, and actinides. Transition metals include, for example, iron and copper. Halogens may be found in group 17 of the periodic table. Non-limiting examples of halogens include naturally occurring fluorine, chlorine, bromine, iodine, and astatine, and artificially created ununseptium. Non-limiting examples of metal halides include, for example, ferric chloride and cupric chloride.

An organic acid is an acid that contains carbon and hydrogen. The at least one organic acid may be either an aliphatic or aromatic compound. The at least one organic acid may be a short-chain organic acid. In this application, a “short” chain organic acid is an acid with an aliphatic tail that has less than seven carbon atoms. The at least one short chain organic acid may comprise at least one carboxylic acid. Carboxylic acid is an organic acid having at least one carboxyl group, which is a functional group having a carbonyl group and a hydroxyl group. Non-limiting examples of carboxylic acids include acetic acid, citric acid, and lactic acid. The surfactant may be an anionic surfactant, such as, for example, DOWFAX™ 3B2 (DF3B2), available from The Dow Chemical Company, which comprises benzenesulfonic acid, decyl(sulfophenoxy)-, disodium salt; benzenesulfonic acid, oxybis(decyl)-, disodium salt; sulfuric acid, disodium salt; and water. The organic acid may act as a surfactant and an etching agent. The organic acid may be used in addition to or instead of a surfactant. In some embodiments, the organic acid, such as a carboxylic acid (e.g. citric acid), may be used, and the surfactant, such as DF3B2, may be omitted. In some embodiments, the organic acid may be required to penetrate through the top coat layer to etch the electrically conductive layer that is disposed between the top coat layer and the hard coat layer.

In some embodiments, an etchant may comprise a first mineral acid, a second mineral acid, and either a surfactant or an organic acid. In some embodiments, the organic acid may be a short-chain organic acid. In some embodiments, the short-chain acid may be a carboxylic acid, such as citric acid. In a first example, the etchant may comprise 40 to 50% by weight of phosphoric acid (H₃PO₄) and 10% to 20% by weight of nitric acid (HNO₃), and either 0.01% by weight of surfactant DF3B2, 0.01-15% by weight of citric acid (C₆H₈O₇), 0.01-15% by weight of acetic acid (C₂H₄O₂), or 0.01-15% by weight of lactic acid (C₃H₆O₃). In a second example, the etchant may comprise about 42.5 wt % H₃PO₄, 13.75 wt % HNO₃, and 0.01 wt % DF3B2. In a third example, the etchant may comprise about 45 wt % H₃PO₄, 17.5 wt % HNO₃, and 5 wt % C₆H₈O₇. In a third example, the etchant may comprise about 45 wt % H₃PO₄, 15 wt % HNO₃, and 0.01 wt % DF3B2.

### Radiation Source

A radiation source having the wavelength range of that is absorbed by the radiation absorbing substance can be used to reveal the invisible pattern. The radiation source may be a laser, a lamp, etc. The laser may be any suitable laser, for example, an excimer laser, a solid-state laser, such as a diode-pumped solid state laser, a semiconductor laser, a gas laser, a chemical laser, a fiber laser, a dye laser, or a free electron laser. The pulse duration of the laser may be on the order of nanoseconds, picoseconds, or femtoseconds. The electrically conductive film or the electrically conductive nanostructures may exhibit absorption across a wide spectrum of wavelengths and may accommodate a variety of lasers at different wavelengths. The laser may be an ultraviolet, visible, or an infrared laser. The laser may be a continuous wave laser or a pulsed laser. The laser may be operated at a selected scan speed, repetition rate, pulse energy, and laser power.

### Revealing an Invisible Pattern

A transparent conductive film may be patterned to produce regions of different conductivity. These patterns may be produced in a manner so as to make them invisible. In some cases, invisible patterns are desirable because the transparent conductive film containing such invisible patterns may be positioned near the display, and patterns that are visible would be visible through the display and pose as unnecessary distractions to the viewer from the information being displayed. In these cases, while it is desirable that the pattern be ordinarily invisible, especially in the end product, it may also be desirable that the invisible pattern be made such that the invisible pattern can be revealed under different viewing conditions than viewed by a consumer viewing the end product. This may be beneficial for confirming the existence of the pattern or for applying ink along the pattern.

As discussed above, the transparent conductive film may comprise a radiation absorbing substance that absorbs radiation within a defined band of wavelengths. The patterning process, for example, etching and stripping, may remove the radiation absorbing particles from either the patterned or unpatterned regions so as to provide the necessary contrast between the patterned or unpatterned regions when the transparent conductive is irradiated with radiation within the band of wavelengths that is absorbed by the radiation absorbing substance. The radiation absorbing substance may absorb radiation within a band of wavelengths that is outside the spectrum where the pattern would normally be invisible to the viewer. For example, the pattern may be invisible to a consumer viewing a touch screen in the visible spectrum. In such cases, the radiation absorbing substance may absorb radiation within a band of wavelengths outside the visible spectrum. In an exemplary example, the radiation absorbing substance may absorb radiation within a band of wavelengths in the ultraviolet spectrum. In another example, the radiation absorbing substance may absorb radiation within a band of wavelengths in the infrared spectrum.

### EXEMPLARY EMBODIMENTS

U.S. Provisional Application No. 62/010,489, filed Jun. 11, 2014, entitled “METHOD OF PRODUCING A REVEALABLE INVISIBLE PATTERN IN A TRANSPARENT CONDUCTIVE FILM,” which is hereby incorporated by reference in its entirety, disclosed the following ten (10) exemplary non-limiting embodiments:

A. A transparent conductive film comprising:

at least one patterned region comprising a first concentration of at least one radiation absorbing compound and exhibiting a first surface resistivity,

at least one unpatterned region comprising a second concentration of the at least one radiation absorbing compound and exhibiting a second surface resistivity, the second concentration being different from the first concentration and the second surface resistivity being different from the first surface resistivity,

wherein the at least one patterned region and the at least one unpatterned region are indistinguishable from each other to the unaided human eye, and

further wherein the at least one radiation absorbing compound is capable of rendering the at least one patterned region and at least one unpatterned region distinguishable from each other to the unaided human eye when the at least one radiation absorbing compound is exposed to radiation within a defined band of wavelengths.

B. The transparent conductive film according to embodiment A, wherein the radiation absorbing substance comprises metal oxide.
C. The transparent conductive film according to either of embodiments A or B, wherein the radiation absorbing substance comprises zinc oxide.
D. The transparent conductive film according to any of embodiments A-C, wherein the defined band of wavelengths is within the ultraviolet spectrum of between about 400 nm and about 10 nm.
E. The transparent conductive film according to embodiment A, wherein the defined band of wavelengths is within the infrared spectrum of between about 700 nm to about 1 mm.
F. The transparent conductive film according to any of embodiments A-E, further comprising a conductive layer comprising conductive structures, wherein the at least one radiation absorbing substance is disposed in the conductive layer.
G. The transparent conductive film according to any of embodiments A-F, further comprising a top coat layer, wherein the at least one radiation absorbing substance is disposed in the top coat layer.
H. The transparent conductive film according to any of embodiments A-G, wherein either the first concentration or the second concentration is zero.
J. A method of using the transparent conductive film according to any of embodiments A-H, comprising:

rendering the at least one patterned region and at least one unpatterned region distinguishable from each other to the unaided human eye by increasing exposure of the transparent conductive film to radiation within the defined band of wavelengths.

K. The method according to embodiment J, further comprising:

rendering the at least one patterned region and at least one unpatterned region to be once again indistinguishable from each other to the unaided human eye by decreasing exposure of the transparent conductive film to radiation within the defined band of wavelengths.

### EXAMPLES

### Materials

All materials used in the following examples are readily available from standard commercial sources, such as Sigma-Aldrich Co. LLC (St. Louis, Mo.) unless otherwise specified. All percentages are by weight unless otherwise indicated. The following additional methods and materials were used.

CAB 381-20 is a cellulose acetate butyrate resin available from Eastman Chemical Co. (Kingsport, Tenn.). It has a glass transition temperature of 141° C.

CAB 553-0.4 is a cellulose acetate butyrate resin available from Eastman Chemical Co. (Kingsport, Tenn.). It has a glass transition temperature of 136° C.

n-propyl acetate is available from Oxea Corp.

SR399 (dipentaerythritolpentaacrylate, Sartomer) is a clear liquid, with a molecular weight of 525 g/mol; its structure is shown below:

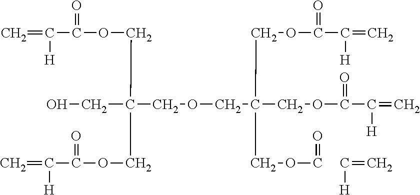

SLIP-AYD® FS 444 (polysiloxane in dipropylene glycol, Elementis) is a liquid additive for increasing surface slip and mar resistance of water borne and polar solvent borne coatings.

X-CURE 184 is a 1-hydroxycyclohexylphenone photoinitiator or curing agent available from Dalian.

CHIVACURE® 300 is a photoinitiator available from Chitec Technology Co., Ltd.

BUTVAR® B-72 is a thermoplastic acrylic resin available from Solutia Inc.

ZnO is zinc oxide, available in 20 nm or 40 nm average particle diameter from BYK Additives and Instruments.

### Example 1

### Preparation of Top Coat Solutions

A 15% CAB polymer premix solution was prepared by mixing CAB 553-0.4 into denatured ethanol and methanol. The resulting CAB polymer premix solution was filtered prior to use.

A masterbatch top coat solution was prepared by adding to 1 part by weight of CAB polymer premix solution, 0.900 parts by weight of SR399 in denatured ethanol at a 1:1 ratio, 1.025 parts by weight of 5% X-CURE 184 in n-propyl acetate, 0.030 parts by weight of 10% SLIP-AYD FS444 in denatured ethanol, 0.281 parts by weight of 2-MP in denatured ethanol, 0.721 parts by weight of denatured ethanol, and 0.442 of n-butanol. The masterbatch top coat solution had 15% solids.

Finished top coat solutions were prepared by adding various loadings of ZnO having different average particle diameters to aliquots of the master batch solution: 1) Control with no added ZnO, 2) ZnO having an average particle diameter of 40 nm dispersed in water or methyl propanol acetate at different ratios of ZnO to top coat solution (0.05:1, 0.03:1, or 0.01:1) while maintaining the 15% solids content, and 3) ZnO having an average particle diameter of either 20 nm or 40 nm dispersed in water or methyl propanol acetate at a selected same ratio of ZnO to top coat solution.

Each of the finished top coat solution was spin coated at 1000 rpm onto three identical glass slide substrates in which one was the control, one for performing the etching step, and one for performing the etching and stripping steps. Coated substrates were then dried in an oven at 120° F. for 2 min followed by two pass UV curing with a Fusion 300 UV-H lamp at 30 ft/min speed to form the top coat layer.

### Evaluation of Films

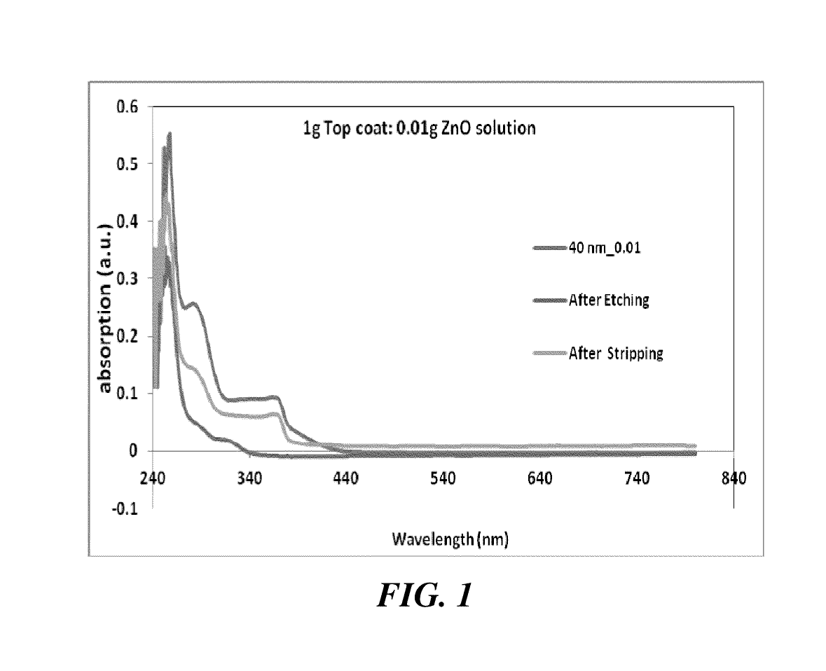

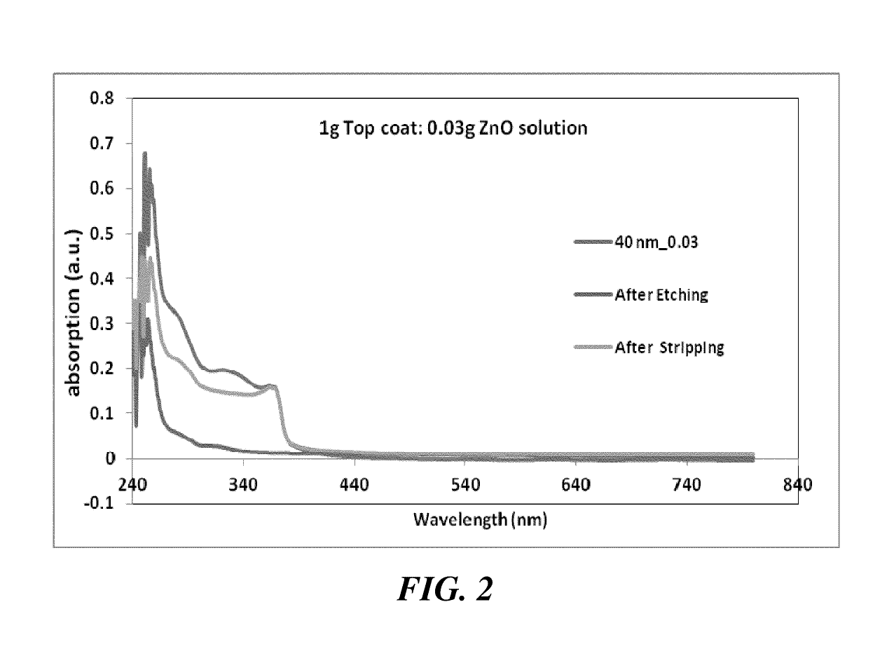

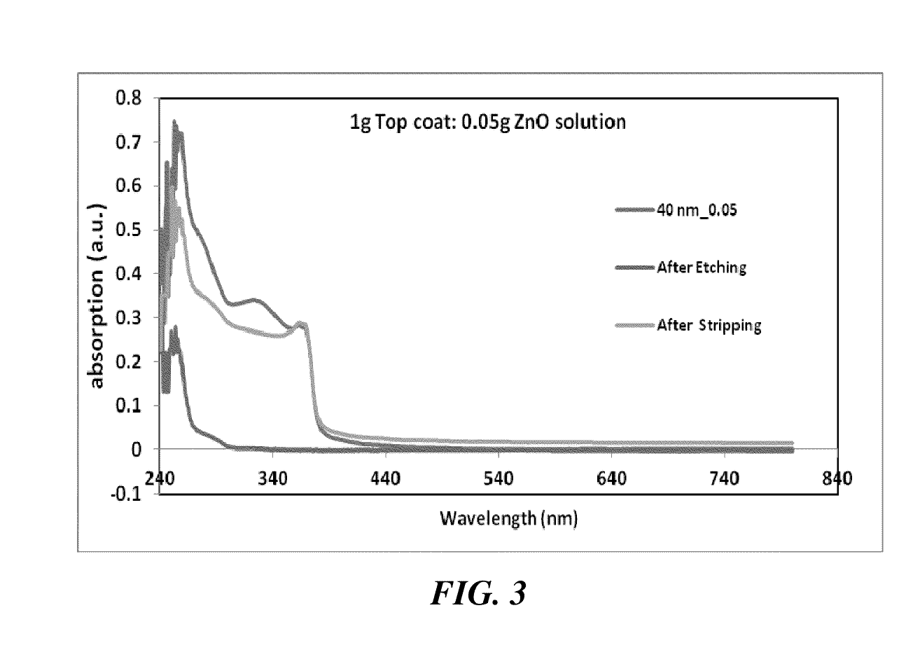

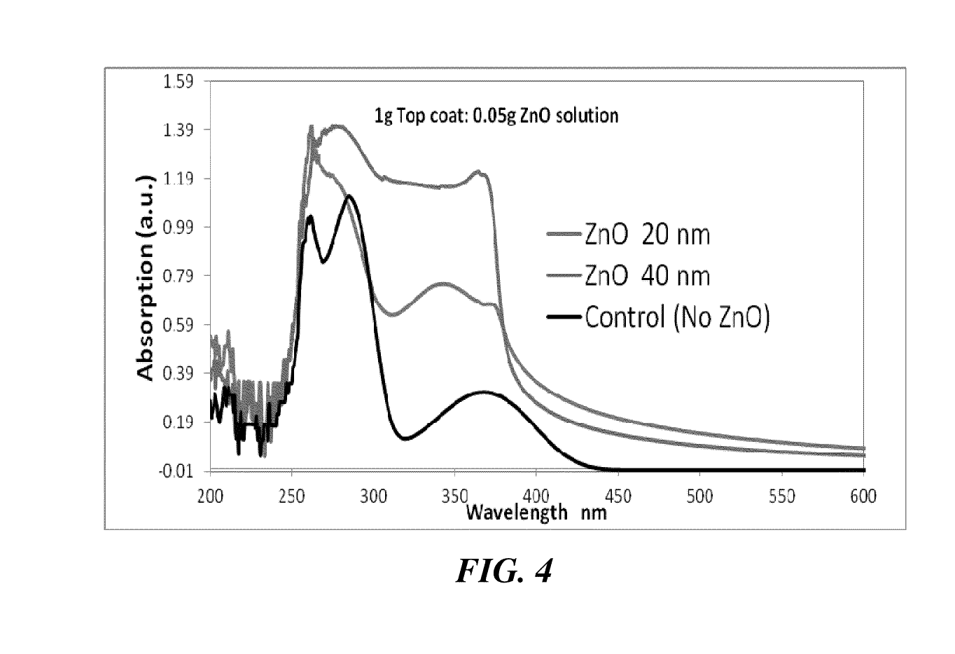

Ultraviolet-visible spectra of the films having top coats with different ratios of ZnO to top coat of 0.01:1, 0.03:1, and 0.01:5 and ZnO having an average particle diameter 40 nm are shown in FIGS. 1, 2, and 3, respectively. FIGS. 1-3 suggest that films with a greater amount of ZnO per 1 g of top coat may result in greater contrast of the pattern under ultraviolet radiation as perceived by the human eye between before or after etching and after stripping. FIG. 4 is an ultraviolet-visible spectra of films having a top coat that has a ZnO to top coat ratio of 0.01 to 5 and having no ZnO or ZnO with an average particle diameter of 20 nm or 40 nm.

FIG. 4 suggests that films with ZnO having a greater average particle diameter at the same ZnO to top coat ratio may result in greater contrast of the pattern under ultraviolet radiation as perceived by the human eye between before or after etching and after stripping.

Observations of pattern visibility under ultraviolet radiation and haze measurements were obtained of the samples having a top coat containing ZnO having an average particle diameter of either 20 nm or 40 nm and a ratio of ZnO to top coat of 0.03 g to 1 g. The haze was measured for the control (or comparative) sample Com-1-1 without ZnO, the film sample 1-1 containing ZnO having an average particle diameter of 20 nm, and the film sample 1-2 containing ZnO having an average particle diameter of 40 nm. Both the observations and haze are shown in Table I. The data suggests that while ZnO having a greater average particle diameter appears to slightly improve the visibility of the pattern under ultraviolet radiation to the human eye, the film may suffer from a slight increase in haze.

TABLE I

| | | Ratio of ZnO | | |
|---|---|---|---|---|
| | Diameter | to Top Coat | | Pattern |
| | of ZnO | Solution | Haze | Visible under |
| Sample | (nm) | (g/g) | (%) | UV? |
| Com-1-1 | — | 0.03/1 | 1.35 | No |
| 1-1 | 20 | 0.03/1 | 1.37 | Yes |
| 1-2 | 40 | 0.03/1 | 1.41 | Yes |

### Example 2

### Silver Nanowires

Silver nanowires having approximate diameters of 33 nm and approximate lengths ranging from 13-17 μm were used.

### Preparation of Silver Nanowire Solutions

A CAB polymer premix solution was prepared by mixing 718 parts by weight of CAB 381-20 with 6460 parts by weight of n-propyl acetate for a solution of 10% solids. The resulting CAB polymer premix solution was filtered prior to use.

7178 parts by weight of the CAB polymer premix solution was combined with 2900 parts by weight of ethyl lactate, 2971 n-propyl acetate, 3019 parts by weight of isopropanol, and 12931 parts by weight of a 1.85% solids dispersion of silver nanowires in isopropanol to form a silver nanowire coating dispersion at 3.3% solids.

ZnO having an average diameter of either 20 nm or 40 nm were added to the silver nanowire coating solutions at ratios of ZnO to silver nanowire solution of 0.005 g to 1 g, 0.01 g to 1 g, 0.02 g to 1 g, or 0.04 g to 1 g. Only the masterbatch top coat solution as described in Example 1 was prepared.

### Preparation of Transparent Conductive Films

The finished silver nanowire coating dispersions were coated on a gravure coater onto PET substrates and dried in an oven at 250° F. for 2 min to form a silver nanowire layer. Each of the finished top coat solution was gravure coated onto a silver nanowire coated substrate and dried in an oven at 120° F. for 2 min followed by two pass UV curing with a Fusion 300 UV-H lamp at 30 ft/min speed to form the top coat layer.

### Patterning of Films

A mask was screen printed onto each of the transparent conductive films. An etchant was applied to each of the transparent conductive films for 60 seconds at 35° C., rinsed, and dried. The mask was stripped from each of the transparent conductive films.

Observations of pattern visibility under ultraviolet radiation and haze measurements were obtained of the samples having a silver nanowire layer containing ZnO having an average particle diameter of either 20 nm or 40 nm and a ratio of ZnO to top coat of 0.005 g to 1 g, 0.01 g to 1 g, 0.02 g to 1 g, or 0.04 g to 1 g. The haze was measured for the control (or comparative) samples and samples containing ZnO. Both the observations and haze are shown in Table II. Compared to Example 1 where ZnO was added to the top coat solution, the pattern under ultraviolet radiation appears less visible to the human eye.

TABLE II

| | | Ratio of ZnO | | |
|---|---|---|---|---|
| | Diameter | to Silver | | Pattern |
| | ZnO | Solution | Haze | Visible under |
| Sample | (nm) | (g/g) | (%) | UV? |
| Com-2-1 | — | — | 1.39 | No |
| 2-1 | 20 | 0.005/1 | 1.44 | Yes |
| 2-2 | 40 | 0.005/1 | 1.43 | Yes |
| Com-2-2 | — | — | 1.32 | No |
| 2-3 | 20 | 0.01/1 | 1.36 | Yes |
| 2-4 | 40 | 0.01/1 | 1.37 | Yes |
| Com-2-3 | — | — | 1.32 | No |
| 2-5 | 20 | 0.02/1 | 1.44 | Yes |
| 2-6 | 40 | 0.02/1 | 1.49 | Yes |
| Com-2-4 | — | — | 1.15 | No |
| 2-7 | 20 | 0.04/1 | 1.49 | Yes |
| 2-8 | 40 | 0.04/1 | 1.50 | Yes |

### Example 3

The silver nanowires used were described in Examples 1 and 2. The silver nanowire solutions were prepared as described in Example 1. The top coat solutions were prepared as described in Example 1, except that finished solutions contained ZnO having an average particle diameter of either 20 nm or 40 nm at ratios of ZnO to CAB in top coat of 0.04 g to 1 g, 0.06 g to 1 g, 0.08 g to 1 g, 0.10 g to 1 g, 0.12 g to 1 g, and 0.20 g to 1 g. The transparent conductive films were prepared and patterned as described in Example 1.

Table III shows the haze, surface resistivity, and observations of pattern visibility for the control sample and top coat having ZnO of average particle diameter of 20 nm or 40 nm at ratios of ZnO to CAB in top coat of 0.04 g to 1 g, 0.06 g to 1 g, 0.08 g to 1 g, 0.10 g to 1 g, 0.12 g to 1 g, and 0.20 g to 1 g.

TABLE III

| | | | | | Pattern |
|---|---|---|---|---|---|
| | Diameter | Ratio of ZnO | | Surface | Visibility under |
| | of ZnO | to CAB in | Haze | Resistivity | Ultraviolet |
| Sample | (nm) | Top Coat | (%) | (ohms/sq) | Radiation |
| Com-3-1 | — | — | 1.11 | 75 | No |
| 3-2 | 20 | 0.04 | 1.14 | 77 | Yes |
| 3-3 | 20 | 0.06 | 1.14 | 76 | Yes |
| 3-4 | 20 | 0.08 | 1.16 | 78 | Yes |
| 3-5 | 20 | 0.10 | 1.16 | 77 | Yes |
| 3-6 | 20 | 0.12 | 1.17 | 78 | Yes |
| 3-7 | 20 | 0.20 | 1.19 | 76 | Yes |
| 3-8 | 40 | 0.04 | 1.13 | 76 | Yes |
| 3-9 | 40 | 0.06 | 1.14 | 74 | Yes |
| 3-10 | 40 | 0.08 | 1.17 | 79 | Yes |
| 3-11 | 40 | 0.10 | 1.16 | 79 | Yes |
| 3-12 | 40 | 0.12 | 1.17 | 76 | Yes |
| 3-13 | 40 | 0.20 | 1.20 | 76 | Yes |

### Example 4

### Silver Nanowires

Silver nanowires having approximate diameters of 33 nm and approximate lengths ranging from 13-17 μm were used.

### Preparation of Silver Nanowire Solutions

A B-72 polymer premix solution was prepared by mixing 60 parts by weight of BUTVAR B-72 into 388 parts by weight of methanol and 1552 parts by weight of isopropanol.

2000 parts by weight of the BUTVAR B-72 polymer premix solution was combined with 14360 parts by weight of isopropanol, 2000 parts by weight of ethanol, 1620 parts by weight of a 1.85% solids dispersion of silver nanowires in isopropanol to form a silver nanowire coating dispersion at 0.450% solids.

### Preparation of Top Coat Solutions

A top coat master batch solution was prepared by adding to 3000 parts by weight of a 5% CAB 171-15 solution, 450 parts by weight of SR399, 450 parts by weight of n-propyl acetate, 3 parts by weight of SLIP-AYD FS-444, 27 parts by weight of n-propyl acetate, 6.757 parts by weight of 2-methylpyrimidine (2-MP), 668.94 parts by weight of n-propyl acetate, 20300 parts by weight of n-propyl acetate, 4570 parts by weight of n-butyl acetate, 50 parts by weight of CHIVACURE 300, and 950 parts by weight of n-propyl acetate. The top coat master batch solution had a solids content of 2.16%.

Finished top coat solutions were prepared by adding various loadings of ZnO in amounts of 0 g, 0.3 g, and 0.6 g to aliquots of the masterbatch solution while each maintained a solids content of 2.16%.

### Preparation of Transparent Conductive Films

The finished silver nanowire coating dispersions were coated on a slot die coater onto PET substrates and dried in an oven at 250° F. for 2 min to form a silver nanowire layer. Each of the finished top coat solution was slot die coated onto a silver nanowire coated substrate and dried in an oven at 120° F. for 2 min followed by one pass UV curing with a Fusion 300 UV-H lamp at 30 ft/min speed to form the top coat layer.

### Patterning of Films

A mask was screen printed onto each of the transparent conductive films. An etchant was applied to each of the transparent conductive films for 60 seconds at 35° C., rinsed, and dried. The mask was stripped from each of the transparent conductive films.

### Evaluation of Films

The haze, light transmission, surface resistivity, and observation of pattern visibility were measured for the control (or comparative) samples and samples containing ZnO having an average particle diameter of 20 nm at 0.3 parts by weight of ZnO and 0.6 parts by weight of ZnO, as shown in Table IV.

TABLE IV

| | | | Light | Surface | Pattern |
|---|---|---|---|---|---|
| | Amount of | Haze | Transmission | Resistivity | Visibility |
| Sample | ZnO | (%) | (%) | (ohms/sq) | under UV? |
| Com-4-1 | — | 1.03 | 91.4 | 106 | No |
| 4-1 | 1x | 1.42 | 90.3 | 103 | Yes |
| 4-2 | 2x | 1.70 | 90 | 101 | Yes |

The invention has been described in detail with reference to specific embodiments, but it will be understood that variations and modifications can be effected within the spirit and scope of the invention. The presently disclosed embodiments are therefore considered in all respects to be illustrative and not restrictive. The scope of the invention is indicated by the claims and all changes that come within the meaning and range of equivalents thereof are intended to be embraced therein.

What is claimed:

1. A transparent conductive film comprising:
at least one patterned region comprising a first concentration of at least one radiation absorbing compound and exhibiting a first surface resistivity,
at least one unpatterned region comprising a second concentration of the at least one radiation absorbing compound and exhibiting a second surface resistivity, the second concentration being different from the first concentration and the second surface resistivity being different from the first surface resistivity,
wherein the at least one patterned region and the at least one unpatterned region are indistinguishable from each other to the unaided human eye, and
further wherein the at least one radiation absorbing compound is capable of rendering the at least one patterned region and at least one unpatterned region distinguishable from each other to the unaided human eye when the at least one radiation absorbing compound is exposed to radiation within a defined band of wavelengths.

2. The transparent conductive film according to claim 1, wherein the radiation absorbing substance comprises metal oxide.

3. The transparent conductive film according to claim 1, wherein the radiation absorbing substance comprises zinc oxide.

4. The transparent conductive film according to claim 1, wherein the defined band of wavelengths is within the ultraviolet spectrum of between about 400 nm and about 10 nm.

5. The transparent conductive film according to claim 1, wherein the defined band of wavelengths is within the infrared spectrum of between about 700 nm to about 1 mm.

6. The transparent conductive film according to claim 1, further comprising a conductive layer comprising conductive structures, wherein the at least one radiation absorbing substance is disposed in the conductive layer.

7. The transparent conductive film according to claim 1, further comprising a top coat layer, wherein the at least one radiation absorbing substance is disposed in the top coat layer.

8. The transparent conductive film according to claim 1, wherein either the first concentration or the second concentration is zero.

9. A method of using the transparent conductive film according to claim 1, comprising:
rendering the at least one patterned region and at least one unpatterned region distinguishable from each other to the unaided human eye by increasing exposure of the transparent conductive film to radiation within the defined band of wavelengths.

10. The method according to claim 9, further comprising:
rendering the at least one patterned region and at least one unpatterned region to be once again indistinguishable from each other to the unaided human eye by decreasing exposure of the transparent conductive film to radiation within the defined band of wavelengths.
